(19) United States
(12) Patent Application Publication
(10) Pub. No.: US 2007/0265853 A1
(43) Pub. Date: Nov. 15, 2007

(54) Database Mechanism

(76) Inventors: David R. Hall, Provo, UT (US); Travis Bird, Spanish Fork, UT (US); Logan Gillette, Provo, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 11/278,514

(22) Filed: Apr. 3, 2006

(51) Int. Cl. G06Q 10/00; G06Q 30/00

(52) U.S. Cl. 705/1

(57) ABSTRACT

In one aspect of the invention, a database mechanism has a first electronic reference representing a first party and a second electronic reference representing a Limited Liability Company (LLC). The LLC has an operating agreement and at least one Series Limited Liability Company (Series LLC) subject to the operating agreement. The Series LLC has one natural second party who is an employee. The database mechanism has executable code that directs electronic pecuniary transactions that deplete the Series LLC of all assets other than the second party.

### BACKGROUND OF THE INVENTION

Independent contractors may face many challenges associated with their independent status. Some companies do not work with independent contractors, choosing instead to have only employees. One solution the market place has developed is to have independent contractors work for an employer of record. An employer of record may legally be an employer, but instead of having a traditional employer/employee relationship, the independent contractor may be able to secure his or her own work, set rates, and function as an independent contractor normally does. The employer of record may assume the responsibility of paying payroll taxes and bills the independent contractor's client for services rendered. In some cases, the services provided by the employer of record may be costly to the independent contractor and/or client.

Another option for independent contractors is to incorporate and sell their services. This may help overcome the problem of companies not wanting to work with independent contractors because paying for services does not require tax reporting by anyone contracting the independent contractor. The costs for becoming incorporated, however, may be high, and the procedures for becoming incorporated may be confusing and burdensome.

Additionally, independent contractors may be responsible for any tax liabilities at the federal, state, or local levels. Tax regulations for corporations and individuals are often complex and hard to understand for people other than tax professionals. Even if employers of record assumes responsibility for taxes, they may not take over responsibility for all tax liabilities. It is important for independent contractors to be able to know what their tax liabilities are and procedures for calculating and remitting the necessary taxes.

### BRIEF SUMMARY OF THE INVENTION

In one aspect of the invention, a database mechanism may comprise a first electronic reference representing a first party and a second electronic reference representing a Limited Liability Company (LLC). The LLC may comprise an operating agreement and at least one Series Limited Liability Company (Series LLC) that may be subject to the operating agreement. The Series LLC may have only one natural second party who is an employee.

The database mechanism may also comprise a portion of executable code that directs electronic pecuniary transactions that deplete the Series LLC of all assets other than the second party. One benefit of the Series LLC having no other assets after the transaction is for simplifying the automation process of providing pecuniary transaction services.

### BRIEF DESCRIPTION OF THE DRAWINGS

FIG. 1 is a schematic of an embodiment of electronic references in a database mechanism.

FIG. 2 is a schematic of additional embodiments of electronic references in a database mechanism.

FIG. 3 is a perspective diagram of an embodiment of devices that may communicate with a database mechanism.

FIG. 4 is a schematic of an embodiment of a method for electronically creating a Series LLC by a database mechanism.

FIG. 5 is a schematic of an embodiment of a first and second party communication through a database mechanism.

FIG. 6 is a schematic of an embodiment of an input provided by a first party.

FIG. 7 is a schematic of an embodiment of an input provided by a second party.

FIG. 8 is a schematic of an embodiment of a method for creating a contract by a database mechanism

FIG. 9 is a schematic of an embodiment of wage actions provided by a database mechanism.

FIG. 10 is a schematic of an embodiment of a method for handling pecuniary transactions by a database mechanism.

FIG. 11 is a schematic of another embodiment of a method for handling pecuniary transactions by a database mechanism.

FIG. 12 is a schematic of an embodiment of providing payment to tax authorities by a database mechanism.

FIG. 13 is a schematic of an embodiment of a database mechanism's function.

### DETAILED DESCRIPTION OF THE INVENTION AND THE PREFERRED EMBODIMENT

It will be readily understood that the components of the present invention, as generally described and illustrated in the Figures herein, may be arranged and designed in a wide variety of different configurations. Thus, the following, more detailed description of embodiments of the apparatus of the present invention, as represented in the Figures is not intended to limit the scope of the invention, as claimed, but is merely representative of various selected embodiments of the invention.

The illustrated embodiments of the invention will best be understood by reference to the drawings, wherein like parts are designated by like numerals throughout. Those of ordinary skill in the art will, of course, appreciate that various modifications to the apparatus described herein may easily be made without departing from the essential characteristics of the invention, as described in connection with the Figures. Thus, the following description of the Figures is intended only by way of example, and simply illustrates certain selected embodiments consistent with the invention as claimed herein.

In this application, the terms “natural second party” and “second party” are used interchangeably and refer to the same entity.

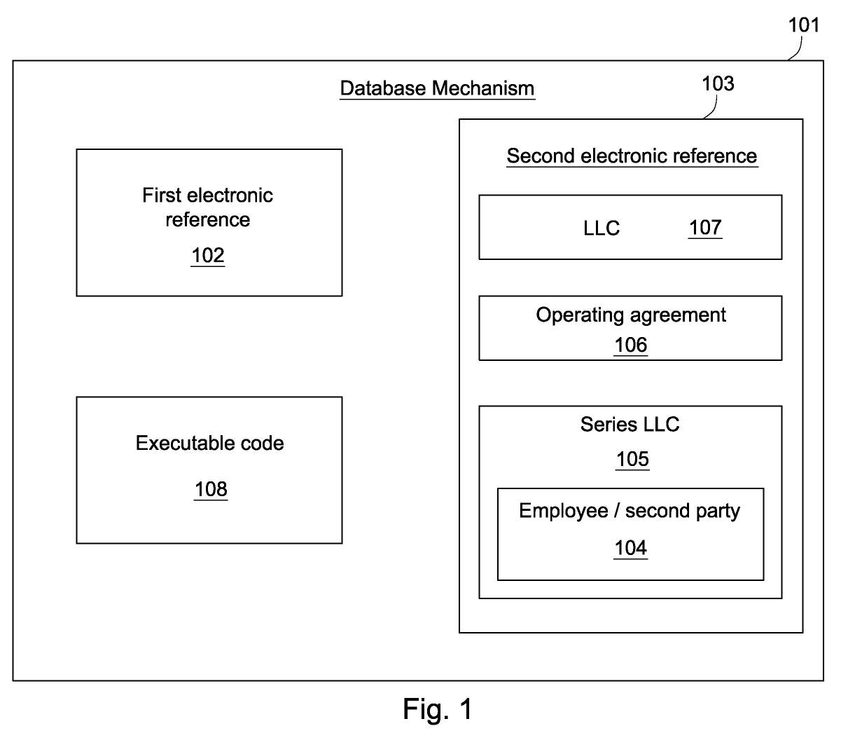

FIG. 1 is a schematic of an embodiment of electronic references in a database mechanism 101. The database mechanism 101 may comprise a first electronic reference 102 representing a first party. The first party may be an individual or a company desiring a laborer to perform a certain task. The database mechanism may also include a second electronic reference 103 representing a Limited Liability Company (LLC) 107 which comprises an operating agreement 106 and at least one Series Limited Liability Company (Series LLC) 105 subject to the operating agreement 106. The Series LLC 105 may have one natural second party 104 who is an employee of the Series LLC. The natural second party 104 may desire to be the laborer for the first party and therefore enter into an agreement with the first party through the database mechanism. The database mechanism also comprises a portion of executable code 108, which allows interaction between the first and second parties. In some embodiments the database mechanism may also comprise another electronic reference representing a third party 110.

The first and second electronic references 102, 103 may comprise information about the respective party such as the party's name, company, address, phone number, title, credit card number, bank account number, or combinations thereof.

The operating agreement 106 may bind the Series LLC 105 with the LLC 107 and include any number of provisions regulating the relationship between the first and second party. Such provisions may require consummating pecuniary transactions between the parties on a substantially regular basis; renewing contracts between the parties on a substantially regular basis; and allowing the natural second party 104 to enter into contracts with the first party. Other provisions in the operating agreement may include requiring the second party 104 to manage the Series LLC's payroll and business tax liabilities, and allowing the second party to manage its own benefits and manage its own expense reimbursements.

The executable code 108 may allow an electronic pecuniary transaction to take place between the first and second parties. Such transactions may include transferring pecuniary assets to at least one of the second party 104, a second-party designated account, a tax authority, a flexible healthcare account, a pension account, a retirement account, a vacation account, a third party, or combinations thereof. The executable code 108 may help in automating the process of conducting electronic pecuniary transactions. The executable code 108 that directs electronic pecuniary transactions may deplete the Series LLC of all assets other than the second party which may ease the second party's 104 burden of preparing tax filings, especially if the second party 104 is unskilled in the tax arena.

The mechanism may further comprise a third electronic reference 110 representing a third party. The third party may be a product distributor, a pecuniary transaction services provider, a financial institution, a contract services provider, a tax authority, or combinations thereof.

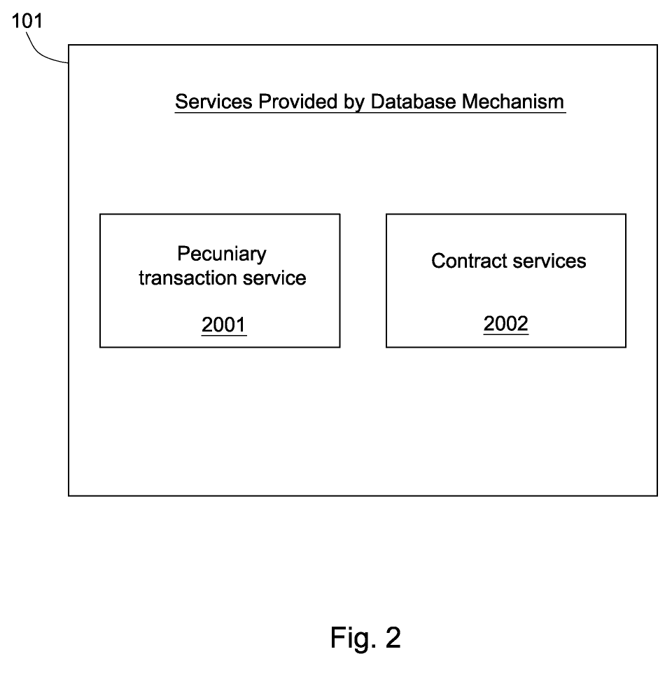

FIG. 2 is a schematic of services that may be provided by the database mechanism. Some services may involve a pecuniary transaction service 2001 which may calculate, garnish, and/or remit taxes; pay fees; transfer pecuniary assets between the parties; generate and/or send W-2s and/or other tax forms; or combinations thereof. Other services 2002 may deal with contracts and include drafting contracts for any of the parties, modifying contracts, filing contracts, reviewing contracts, reviewing contract terms, or combinations thereof.

The services 2001, 2002 may be carried out as functions performed by the executable code 108 of the database mechanism, by an entity operating the database mechanism 101, or by a company contracted to perform the functions. For example, the first and second party may wish to enter into a contract for the Series LLC 105 to perform a service. Each party may input into a field of the database mechanism 101 what they desire to be included in the contract. The inputs may be processed through executable code 108 to produce a contract which can then be reviewed by the parties. In other embodiments, the inputs may then be sent to an attorney who may prepare the contract. An attorney may be able to communicate with the parties to clarify what may have been meant by certain inputs over the phone, through email, or through the database mechanism. Once the contract is agreed upon, both parties may sign the contract. The contract may be signed electronically, such as via the internet, so that both parties have secure access over the database mechanism to view the contract, or the contracts may be signed manually and scanned into the database mechanism. In other embodiments, the contract may be kept by either one of the parties, or the contact may be stored in another manner as preferred by the each set of parties.

These functions may be wholly automated by the database mechanism 101.

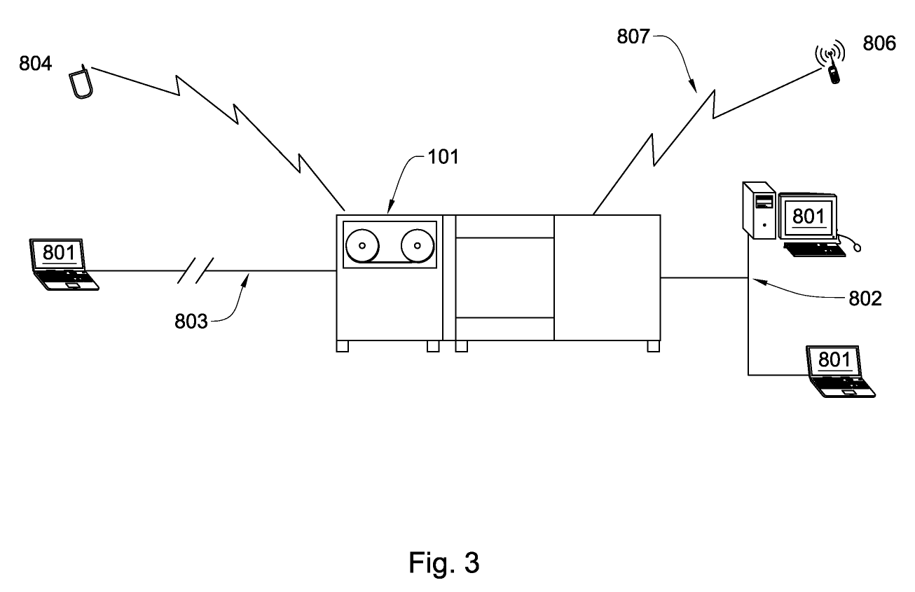

FIG. 3 is a perspective diagram of devices that may communicate with the database mechanism. The database mechanism 101 may receive and/or direct input over a local area network (LAN) 802, a wide area network (WAN) 803, a telephone network, a cellular network, a wireless device 804, or combinations thereof. There are numerous wireless devices 804 that may communicate with the database mechanism. A wireless device 804 may comprise a personal digital assistant (PDA), a computer 801, an infrared transceiver, radio receiver, cellular phones 806, or combinations thereof. The wireless devices may comprise infrared or radio transceivers and may use protocols such as WiFi or Bluetooth.

In some embodiments of the present invention, a party may also use a telephone or cellular network to communicate with the database mechanism 101. Interactions available over the telephone with the database mechanism 101 may include determining an account balance, determining the status of a payment, clocking in, clocking out, making a status report, reviewing reports, or combinations thereof Some cellular phones 806 may comprise a modem which allows the cellular phone to be part of a WAN and therefore communicate with the database mechanism 101. Additionally, a cellular phone 806 may send a text message, a multimedia messaging service (MMS) message, an enhanced messaging service (EMS) message, or combinations thereof to the mechanism 101 via the cellular connection 807.

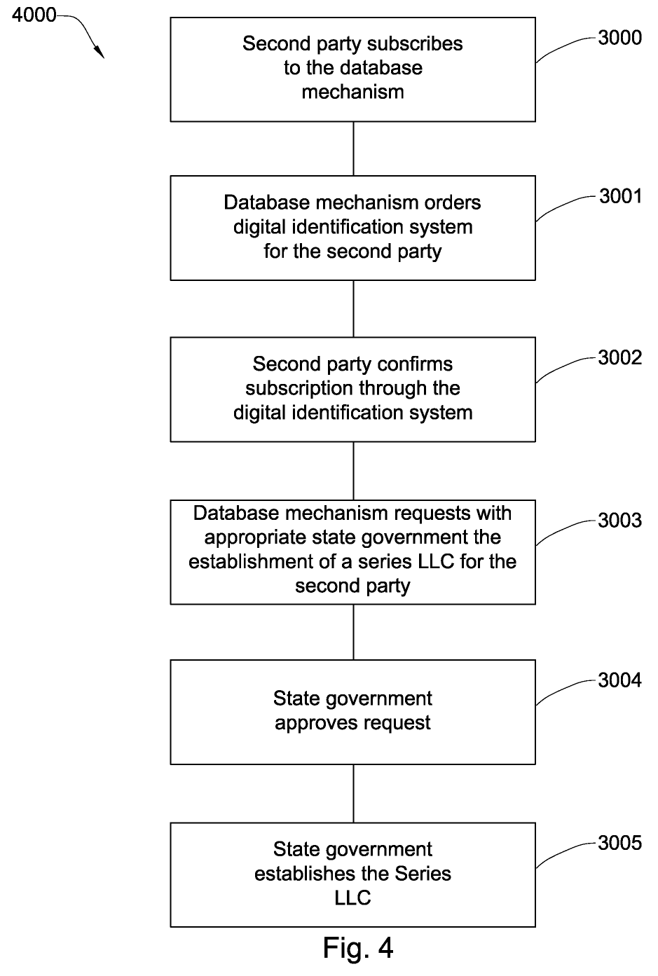

FIG. 4 is a schematic of an embodiment of a method 4000 for electrically creating a Series LLC 105. The method 4000 begins with the second party 104 subscribing 3000 to the database mechanism 101. The second step may be the database mechanism 101 ordering 3001 a digital identification system for the second party 104. When the digital identification system arrives, the second party may confirm 3002 the subscription through the digital identification system. When the confirmation is received, the database mechanism 101 may request 3003 the establishment of a Series LLC 105 for the second party 104. The state government may approve 3004 the request and in so doing, establishes 3005 the Series LLC.

Subscribing 3000 to the database mechanism may be regulated by terms and conditions which include paying a fee, agreeing to the LLC's operating agreement 106, and providing personal information, or combinations thereof.

The digital identification system ordered 3001 by the database mechanism 101 may comprise a digital signature pad, a biometric scanning device, a digital certificate, or combinations thereof.

Once the digital identification system has been used to confirm 3002 the subscription, the second party may indicate to the database mechanism 101 that the necessary information and verification is complete. The database mechanism 101 may automatically and/or electronically request 3003 with the appropriate Department of State that a Series LLC 105 be established. The request may be in the form of an amendment to the LLC's 107 operating agreement 106. The request may be approved 3004 when the amendment is accepted, thereby establishing 3005 the Series LLC. Preferably, the Series LLC 105 is set up in Delaware or another state which allows Series LLCs to be created.

A Series LLC 105 may be treated as a business on its own, and as its parent LLC 107 or other Series LLCs 105 associated with the parent LLC 107 may not be liable for a Series LLC 105. Additionally, any second party 104 who is an employee of a Series LLC 105 is liable for only the Series LLC 105 of which the second party 104 is an employee and not other Series LLCs 105 associated with the parent LLC 107.

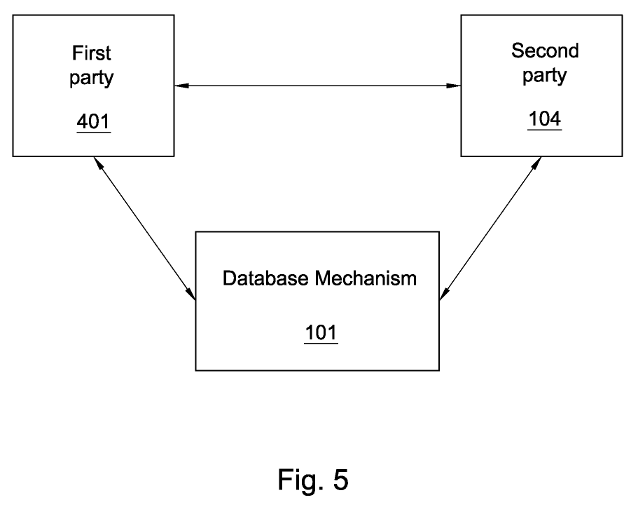

FIG. 5 is a schematic of an embodiment of first and second party 401, 104 communication through a database mechanism 101 and with each other. The first and the second party 401, 104 may find each other on their own or through the database mechanism 101. Either party may input into the database mechanism 101 their requirements for work, which may become searchable over the database mechanism 101. The parties may also communicate with each other to inform the other party of their requirements for work, then input the agreed upon requirements into the database mechanism 101.

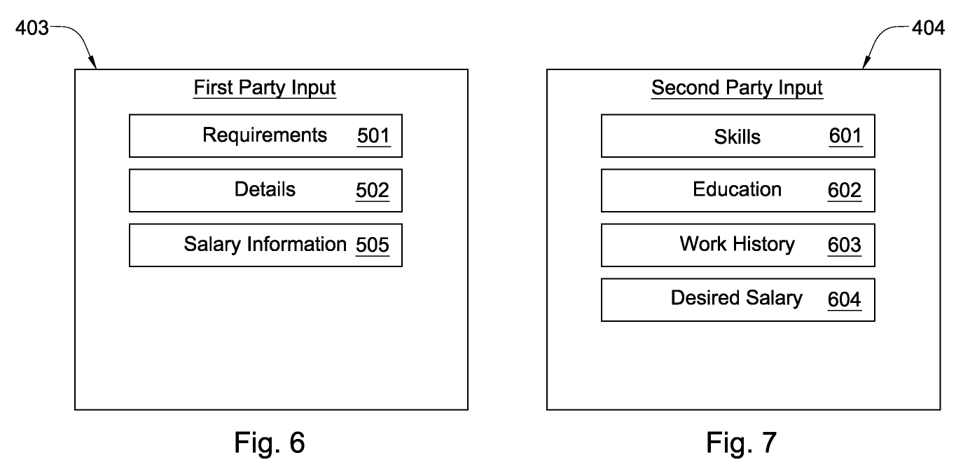

FIG. 6 is a schematic of an embodiment of inputs that may be provided by the first party. The first party 401 may be offering a temporary project or a permanent position through the database mechanism 101. The first party's input for the project or job may comprise requirements 501, details 502, salary information 505, or combinations thereof. Requirements 501 may comprise a list of the necessary skills, education level, the experience, or combinations thereof desired for the second party. The details 502 may describe a project and comprise details about the project's goals, timetable, inherent complications, hours required, compensation rate, or combinations thereof. The salary information 505 may comprise a maximum and/or minimum figure, a pay scale according to education and/or experience, or a combination thereof.

FIG. 7 is a schematic of an embodiment of inputs that the second party may provide. The second party input may comprise a list of skills 601, educational details 602, work history 603, desired salary rates 604, or combinations thereof. The second party input may comprise what is normally found on a resume including an objective, relevant memberships, publications, or combinations thereof.

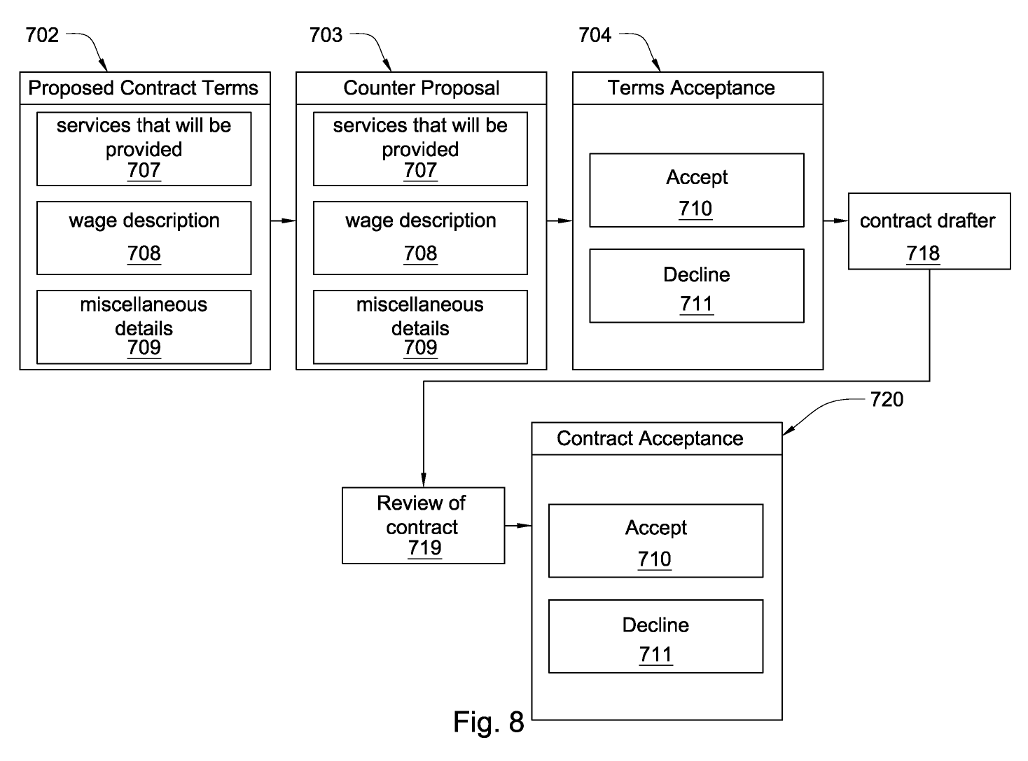

FIG. 8 is a schematic of an embodiment of a method for creating a contract by a database mechanism 101. The contract may be entered into through the database mechanism 101 between a first party 401 and the Series LLC 105 which is represented by the second party 104. Either of the parties may propose terms 702, give counter proposals 703, accept the terms 710, and/or reject 711 the terms. The terms 702 may comprise a description of what services to be provided 707, a wage description 708, miscellaneous details 709, or combinations thereof. The description of what services will be provided 707 may comprise a description of the function(s) the second party 104 is to perform and may be specific or general. The wage description 708 may describe how the second party 104 is compensated. The description 708 may comprise a rate for a specific time period (hourly, weekly, monthly, annually), a single rate for the completion of a project or a project's goal, bonuses, pecuniary benefits, or combinations thereof. The miscellaneous details 709 may comprise provisions that the second party 104 may sign a non-disclosure agreement, that the second party 104 may sign a non-competition agreement, that the second party 104 be given office space, that the second party 104 will be eligible for benefits, that the second party 104 will provide his or her own equipment, or combinations thereof.

A party may send a counter proposal 703 over the database mechanism 101 for the other party to review. The database mechanism 101 may further comprise a plurality of contract templates that available to the parties to help parties not familiar with contract drafting. Once terms have been agreed upon, the first party 401 and the second party 104 may officially accept 710 by clicking on at least one button, providing a digital signature, providing identity verification by using a biometric scanning device, providing a digital certificate, or combinations thereof. The process of creating and entering into a contract may be at least partially automated by the database mechanism 101.

Alternatively, a contract drafter 718 may be used to write the contract instead of using templates. When each party agrees on terms, the terms may be sent to an attorney to draft the contract and return it to the parties to be accepted 710, rejected 711, or reviewed 719.

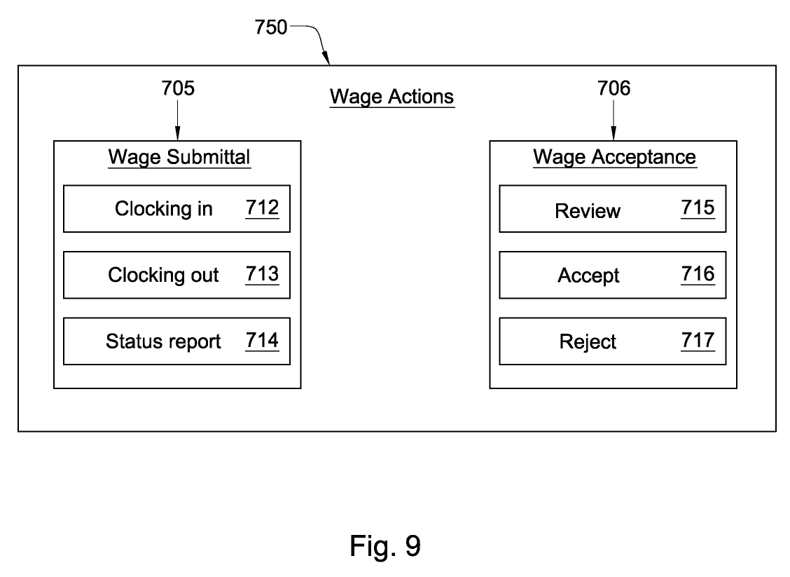

FIG. 9 is a schematic of an embodiment of wage actions provided by a database mechanism. Wage actions 750 performed by the second party may include wage submittal 705 which may include: clocking in 712, clocking out 713, and sending a status report 714. The second party 104 may also be able to provide status reports 714 to the first party 401 over the database mechanism. The status reports 714 may include a report on the work performed, and time stamps for clocking in 712 and out 713.

The first party 401 may perform a wage request where he may review, accept and/or reject the wages requested by the second party. The first party 401 may have the option to review 715 the hours worked or reports 714 submitted by the second party 104. If accepted 716, the mechanism 101 may begin to facilitate payment. If rejected, 717, the mechanism 101 may notify the second party 104 and which allows the parties to communicate with each other and resolve the discrepancy. In extreme cases, the parties may not be able to resolve the discrepancy on their own and may either void the contract or involve another party.

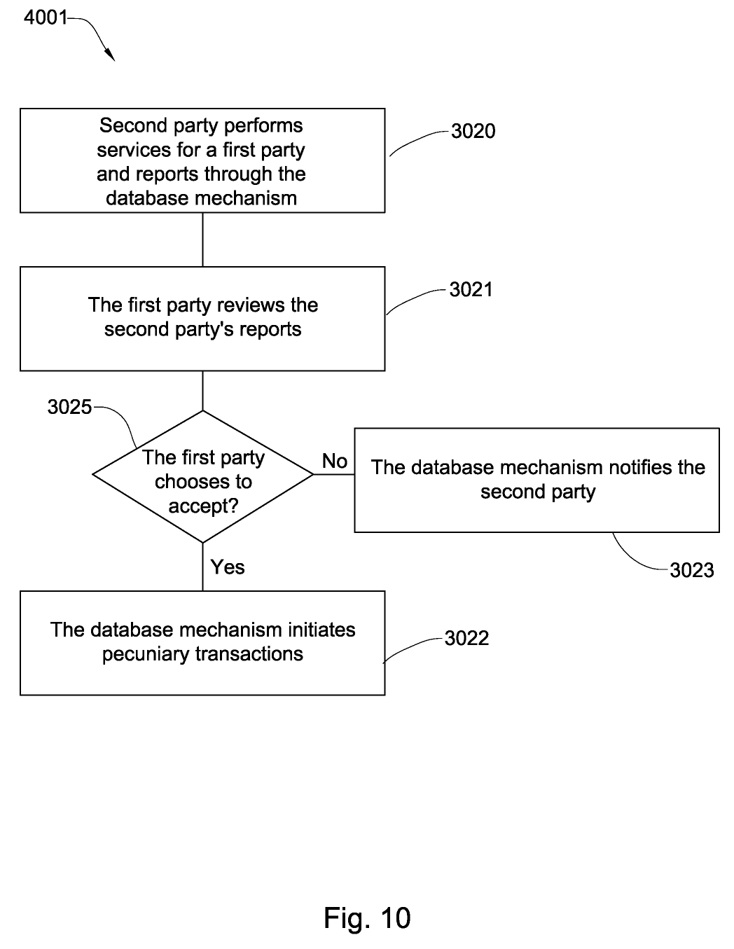

FIG. 10 is a schematic of a method 4001 for handling pecuniary transactions by the database mechanism. A second party 104 representing a Series LLC 105 may perform 3020 services to a first party 401 and submit reports through the database mechanism 101. The first party 401 may review 3021 the reports and then choose 3025 to accept. If the first party 401 does not choose 3025 to accept, the database mechanism 101 may notify 3023 the second party 104. If the first party 401 does choose 3025 to accept, the database mechanism 101 may initiate 3022 pecuniary transactions.

Reports may be submitted by clocking in 712, clocking out 713, submitting status reports 714, submitting time sheets, or combinations thereof and the database mechanism 101 may send an invoice to the first party 401 automatically. The invoice is sent from of the Series LLC 105 because the contract is with the Series LLC 105 and not the second party 104. The first party 401 may receive the invoice automatically, or the first party 401 may view it on the database mechanism 101.

The database mechanism 101 may initiate 3022 pecuniary transactions by sending an authorization to a third party, which may be a first financial institution, which has the first party's bank account. The authorization may comprise batch files which may instruct the first financial institution to transfer a certain sum of pecuniary assets to a second financial institution, which may be a bank related to the Series LLC 105. The database mechanism 101 may have executable code 108 to direct an electronic pecuniary transaction such that the consummation of the transaction results in the Series LLC holding no assets other than the one natural second party. There may be a bank account associated with the Series LLC 105 from which the assets are transferred to second party-designated accounts. The database mechanism 101 may be configured to transfer all pecuniary assets out of the Series LLC—held account so that the balance is zero.

The second party 104 may also designate, through the database mechanism 101, an account and what portion of pecuniary assets should be put into the second party-designated account.

The database mechanism 101 may automate the process outside of any inputs the parties may make. This may be beneficial in that fewer people are needed to perform the transactions or check the process of performing transactions.

Additionally, if the first party chooses 3025 not to accept, the database mechanism may void the contract in addition to notifying 3023 the second party.

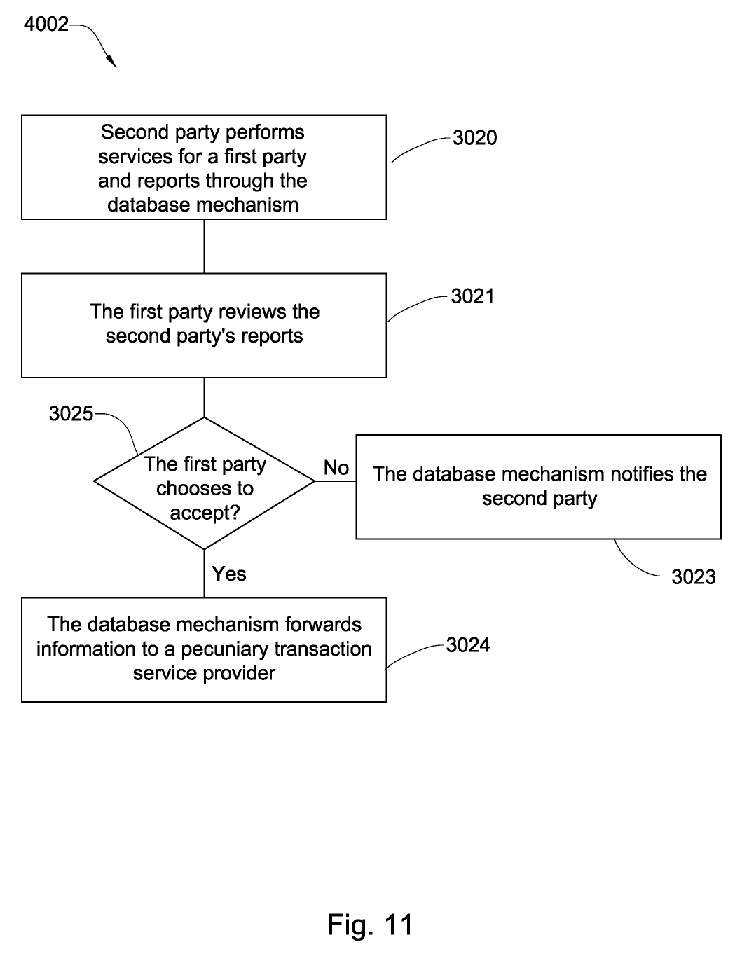

FIG. 11 is a schematic of another embodiment of a method 4002 for handling pecuniary transactions by the database mechanism. In this embodiment when authorizations for pecuniary transactions are generated and sent, they are not sent to a financial institution. Rather, the entity which is responsible for the database mechanism 101 may contract with another party, such as a pecuniary transaction services provider. The provider may then perform functions related to pecuniary transactions such as calculating, garnishing, and/or remitting taxes; paying fees; transferring pecuniary assets between any party; generating and/or sending W-2s and/or other tax forms; or combinations thereof.

If a pecuniary transaction service provider is hired, then when the first party 401 chooses 3025 to accept, the database mechanism 101 may forward 3024 information to a pecuniary transaction service provider.

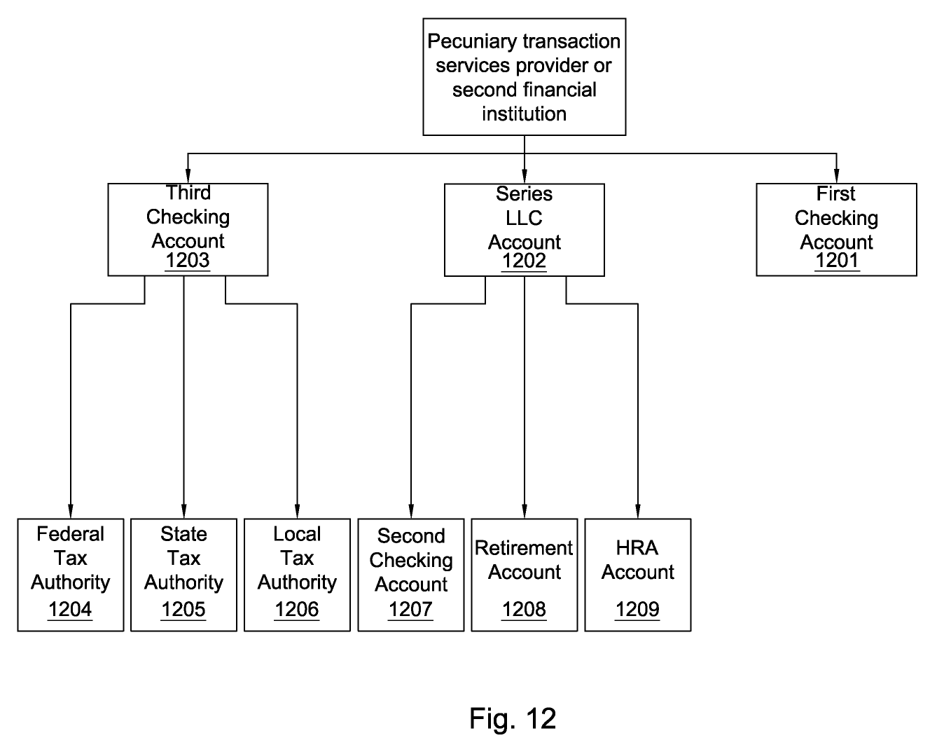

FIG. 12 is a schematic of an embodiment of a method for distributing pecuniary transactions. After pecuniary assets have been transferred from the first party's 401 financial institution 901, they are distributed according to instructions generated by the database mechanism 101 or the second party. The instructions may direct some of the assets to be deposited in a checking account 1201. Other assets may be transferred to tax authorities 1204, 1205, 1206, or combinations thereof In FIG. 12, the pecuniary assets garnished for taxes are put into a another checking account 1203 which are then distributed to a federal, state, or local tax authority 1204, 1205, 1206, or combinations thereof.

Yet other assets may be transferred into a third checking account 1207, or other account associated with the second party, these assets may constitute the second party's wage after his tax withholdings. Additionally, pecuniary assets may be transferred to other second party-designated accounts; such as a bank account, a retirement account 1, a 401(k), an IRA, a Roth IRA, a flexible spending account (FSA, sometimes known as a cafeteria plan), a health reimbursement account (HRA) 1, other accounts the second party 104 may designate, or combinations thereof, before pecuniary assets are transferred into a second checking account 1207.

The second party 104 may receive a W-2 from the Series LLC 105 which is generated by the database mechanism 101 or the pecuniary transaction service provider 950 on behalf of the Series LLC 105, along with a K-1 for the Series LLC 105. With executable code 108 that directs electronic pecuniary transactions that may deplete the Series LLC of all assets other than the second party makes the K-1 form much easier in that the profit of the Series LLC 105 will be zero and the second party 104 may only need to sign the form and file it.

Because fees for corporations, LLCs, and the like are often required by states, the database mechanism 101 may report to the state in which the parent LLC 107 and Series LLC 105 are registered and pay the required maintenance fees.

This process may also be automated. Automating the calculating, garnishing, and/or remitting of taxes and providing tax forms may reduce the number of personnel a company must have to perform those same functions. A further benefit may be that the database mechanism 101 may be programmed with applicable laws so that the first and/or second parties 401, 104 do not inadvertently break any laws. For example, a second party may not know that the limit for deposits into an IRA is $4,000. When that limit is reached, the database mechanism 101 may not allow any more deposits.

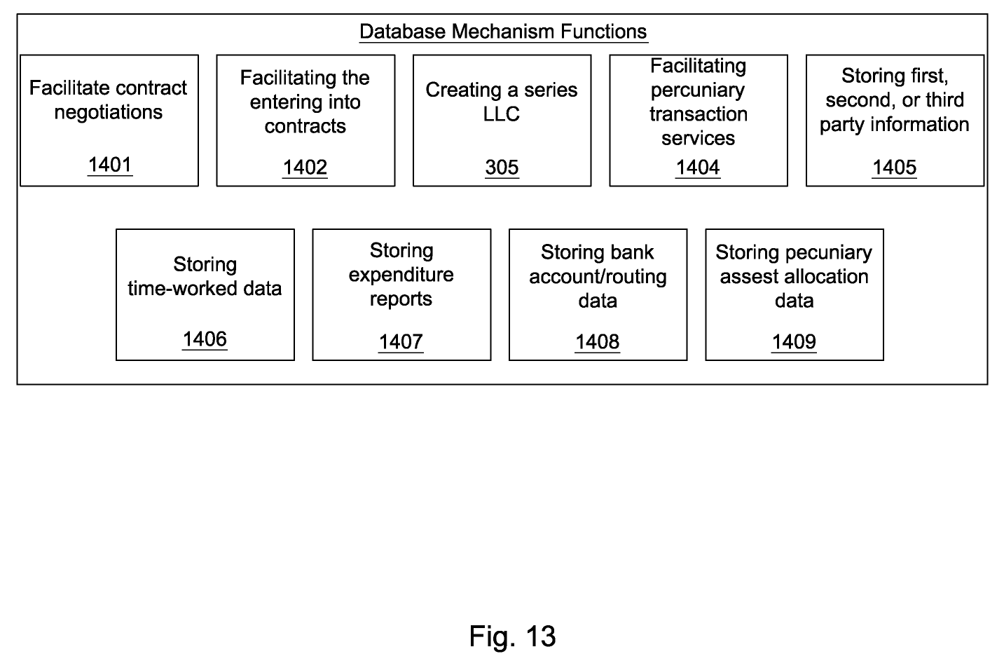

FIG. 13 is a schematic of database mechanism functions. The mechanism 101 may perform the functions comprising facilitating contract negotiations 1401 between a second party 104, a Series LLC 105, and/or a first party 401; facilitating the entering into contract by a second party 104, a Series LLC 105, and/or a first party 401; creating a Series LLC 105, facilitating pecuniary transaction services 1, storing first, second, and third party information 1405; storing time-worked data 1406; storing expenditure reports 1407; storing bank account and/or routing data 1408; storing pecuniary asset allocation data 1409; or combinations thereof. These functions may be automated.

What is claimed is:

1. A database mechanism, comprising:
a first electronic reference representing a first party;
a second electronic reference representing a Limited Liability Company (LLC) comprising an operating agreement and at least one Series Limited Liability Company (Series LLC) subject to the operating agreement;
the Series LLC comprising of only one natural second party who is an employee; and
a portion of executable code that directs electronic pecuniary transactions that deplete the Series LLC of all assets other than the second party.

2. The mechanism of claim 1, wherein the operating agreement comprises provisions that are selected from the group consisting of consummating pecuniary transactions between the parties on a substantially regular basis; renewing contracts between the parties on a substantially regular basis; and allowing the natural second party 104 to enter into contracts with the first party; recognizing the second party's authority in the Series LLC for entering into employment contracts, managing payroll for the second party, managing the second party's business tax liabilities, managing the second party's own benefits, managing the second party's own expense reimbursements; or combinations thereof.

3. The mechanism of claim 1, wherein the electronic pecuniary transaction comprises transferring pecuniary assets to the second party, a second party-designated account, a tax authority, a flexible healthcare account, a pension account, a retirement account, a vacation account, or combinations thereof.

4. The mechanism of claim 1, further comprising a third electronic reference representing a third party.

5. The mechanism of claim 4, wherein a third party comprises a product distributor, a pecuniary transaction services provider, a financial institution, a contract services provider, a tax authority, or combinations thereof.

6. The mechanism of claim 1, wherein the database mechanism automatically orders at least one product for delivery to the Series LLC, first party, or second party.

7. The mechanism of claim 6, wherein the product comprises a digital identification system.

8. The mechanism of claim 1, further comprising representing pecuniary transaction services provided by the database mechanism.

9. The mechanism of claim 8, wherein the pecuniary transaction services comprise calculating, garnishing, and/or remitting taxes; paying fees; transferring pecuniary assets between any party; generating and/or sending W-2s and/or other tax forms; or combinations thereof.

10. The mechanism of claim 1, further comprising contract services provided by the database mechanism.

11. The mechanism of claim 10, wherein contract services comprise drafting contracts, modifying contracts, filing contracts, reviewing contracts, reviewing contract terms, or combinations thereof.

12. The mechanism of claim 1, wherein a contract may be entered into through the database mechanism.

13. The mechanism of claim 12, wherein the first and second parties provide confirmation of entrance into the contract by clicking on at least one button, providing a digital signature, providing identity verification by using a biometric scanning device, providing a digital certificate, or combinations thereof.

14. The mechanism of claim 1, the mechanism receives and/or directs input a local area network (LAN), a wide area network (WAN), a telephone network, a cellular network, a wireless device, or combinations thereof.

15. The mechanism of claim 14, wherein the wireless device comprises a personal digital assistant (PDA), a computer, cellular phones, or combinations thereof.

16. The mechanism of claim 15, wherein the wireless devices comprise infrared or radio transceivers and use protocols such as WiFi or Bluetooth.

17. The mechanism of claim 1, wherein a cellular phone is part of a WAN and communicates with the database mechanism.

18. The mechanism of claim 1, wherein a second party designates an account and what portion of pecuniary assets should be put into the account.

19. The mechanism of claim 1, wherein the database performs the functions of facilitating contract negotiations between a second party, a Series LLC, and/or a first party; facilitating the entering into contracts by a second party, a Series LLC, and/or a first party; creating a Series LLC automatically; facilitating pecuniary transaction services; storing first, second, or third party information; storing time-worked data, expenditure reports, bank account and/or routing data, pecuniary asset allocation data; or combinations thereof.
